(19) United States
(12) Patent Application Publication
(10) Pub. No.: US 2008/0103828 A1
(43) Pub. Date: May 1, 2008

(54) AUTOMATED CUSTOM REPORT GENERATION SYSTEM FOR MEDICAL INFORMATION

(76) Inventors: John R. Squilla, Rochester, NY (US); Joseph P. Di Vincenzo, Rochester, NY (US)

Correspondence Address: Carestream Health Inc,, 150 Verona Street, Rochester, NY, 14608, US

(21) Appl. No.: 11/555,313

(22) Filed: Nov. 1, 2006

(51) Int. Cl. G06F 19/00; G06F 3/00; G06F 17/00

(52) U.S. Cl. 705/3; 715/733; 715/201

(57) ABSTRACT

A medical evaluation system for a procedural event comprises: determining key medical images (10) and medical reports; determining a clinician's preferences (85) for medical records obtained from a physician; determining the clinician's preferences for clinical information system records; determining the clinician's preferences for display of the medical images, medical reports, medical records, and clinical information system records; and displaying the medical images, medical reports, medical records, and clinical information system records.

### FIELD OF THE INVENTION

The area of this invention is clinical reporting systems, especially in preparation for surgery by surgeons and other clinicians and their associates.

### BACKGROUND OF THE INVENTION

Surgeons and other clinicians rely on information to plan and perform their surgeries or procedures. Information takes on many forms: radiological images, medical records, allergies, photographs, reports, consultations and collaborations and more are all utilized in determining the best means to accomplish the surgical goal. Most of the time, these records are in various locations, on multiple systems, non-digital in nature (paper) and difficult to place into a common system.

A large source of this pre-surgical information is radiological in nature, and there are many systems that provide a digital record of this. An example is Kodak RIS/PACS solution (www.kodak.com/global/en/health/productsByType/pacs/pacs_Product.jhtml?pq-path=5809), Kodak VIPArchive, Kodak DIRECTVIEW DR Systems and other radiology systems including MRI, CT, PET and ultrasound image capture. These patient imaging systems provide entire image records of a patient's scans and X-rays. These systems often provide dozens to hundreds of images that are analyzed by radiologists who summarize and report their findings. Often, a surgeon uses some of these images, in planning the surgery that may result from the findings. In some instances, access is provided to these systems by surgeons and other clinicians. These patient imaging systems are extremely powerful in their capabilities and features, but require substantial training and experience to become proficient with them. In addition, easy access to other patient information systems (medical records, Emergency Department information, outpatient radiology clinics, non-radiological procedures and others) is not provided.

Medical records are also available from primary care physicians and specialists who have examined or performed procedures on patients. Many of these records are paper-based but medical record systems, such as SOAPWare from Docs, Inc. provide for digital medial record keeping. The U.S. Veteran's Administration has a multimedia medical record system called VISTA that is an excellent example of a record that contains text, images, graphics and other data (www.va.gov/vdl/). In addition, tools like scanners (HP, Epson, etc) and the Anoto Pen (www.anoto.com/) allow for paper-based technology to be digitized for use in computerized medical information systems.

There are also a number of software products that allow for teleconferencing of information including NetMeeting from Microsoft and WebEx (www.webex.com) which allows for the real-time exchange of information for collaboration. In addition, real-time exchange of image information is available through the use of the JPEG 2000 standard (wwwjpeg.org/jpeg2000/). Streaming technology has been shown on may applications including QuickTime and, specifically for medical applications, through Medical Insights (www.medical-insight.com/) which provides streaming technology for all types of medical information.

The American Society of Plastic Surgeons and the Plastic Surgery Educational Foundation have published a series of image templates for Plastic Surgery that not only show what pictures should be taken, but also the procedure for capturing them (“Photographic Standards in Plastic Surgery”).

All of this information can lead to “information overload” and surgeons and clinicians do not have the time to handle all of the information that can be made available to them. A system that can automatically filter information and arrange it in an easy-to-use manner where pertinent information is available quickly would be a useful tool. Several issues, however, stand in the way of this. The answer needs to be specialty-specific (cancer surgery and plastic surgery, for example, would require different sets of information, in most cases). Physicians also have specific needs and wants particular to them, as individuals. Some may prefer a single x-ray while others may prefer a 3-D rendering of the scans. Some prefer a text-based system while others prefer and image or graphic centric system.

The customization and integration of these and other records is the basis of the current invention, as well as the interface to optimize the ease-of-use through hierarchical choices and a multi-modal selections system. Patient medical information acquired, organized and displayed using the present invention enables healthcare professionals and their patients to more effectively evaluate relevant patient images and information. The present invention can be used in a variety of medical situations including pre-procedure patient consultation, second opinions, procedure evaluation and selection, procedure planning, use while performing the surgical/clinical procedure and for post-procedure follow-up. Multimodal selection systems are quite common as seen by voice recognition systems, eye tracking systems, joysticks and other selection methods. The Microsoft OS (Windows 2000, Windows XP) allow for multiple selection means connected at the same time.

Dynamically updates menus are shown in standard web browsers when “favorite” URLs are added to the list using the “add to favorites” option under the “favorites” main menu as seen in Internet Explorer by Microsoft.

U.S. Pat. No. 6,611,846 (Stoodley) describes a “Method And System For Medical Patient Data Analysis.” This application has a diametrically opposite purpose to the present invention as it searches across all patients for data having similar criteria to examine trends and common issues as opposed to providing data for a particular patient as in the present invention.

U.S. Patent Application Publication No. 2006/0150242 (Doyle) describes a system that allows information about a procedure to be made available to patients in an effort to minimize risk to the clinician. It is not intended for use by a clinician for use during a procedure. No mention of medical procedural data or images/reports is claimed.

In U.S. Pat. No. 6,182,047 (Dirbas), a means to provide a logging system for medical visits is described. There is no intent to filter the information for a particular upcoming procedure, no method to determine the preferences of the clinician, and no mention of a system to bring the information together for a specific purpose in a customizable manner. Interactive links to other data is not mentioned.

Currently, surgeons and other clinicians can access systems used by other medical professionals (RIS/PACS, medical record systems, ED systems and other CIS) and use them in their current embodiments. These systems can be very complicated and difficult to master, especially for occasional users. In addition, the systems rarely communicate images and information with each other and generally lack a common user interface, common data format, nor are they customizable. They also do not allow modification of the system by individuals for the purpose of the present invention. RIS/PACS systems do allow access to surgeons and other clinicians other than the radiologists and even provide viewing applications for looking at the radiographic information, even from multiple procedures. They do not, however, integrate the reports with the images, combine the images with other content, or provide access into other systems to combine the information together into a coherent package. In addition, they do not provide many of the features illustrated in the current invention, including: collaboration, history, teaching tools, dynamic and changeable content, and so on. A standard feature of most RIS/PACS systems is the ability for the radiologist to acknowledge certain images as key images. The preference file (below) can be sent to the radiologist to provide him with information that the surgeon or clinician using the custom reporting system desires from the radiologist.

The most common method in use today is to print out the pertinent information (or provide copies of radiological imagery) and view them in the place of interest (OR, office, exam room, et al.). In some cases, the clinician prepares a display of the information on an electronic display in the place of interest, but the burden of all the composition, hierarchy, and the other features of this invention are all left to the clinician to do in a manual manner for each procedure.

The Olympus offering called the “AlphaOR” system (www.olympussurgical.com/index.cfm/page/products.index.cfm/cid/132/navid/89 8/parentid/1) is an example of a system meant to monitor an operating room. This system does provide a method to link to a picture archiving and communication system (PACS) in the institution. However, it does not create a customized reporting system of this and other patient medical information as specified by the surgeon or clinician.

The present invention offers significant advantages to the art mentioned above and can be used with them as well with significant savings in cost, workflow and ease-of-use. A key differentiator of the present invention is the capability for image and information selection and report customization by the surgeon, clinician and their staff who are preparing for the procedure (i.e. allowing them to look-up, electronically ‘pull’ into their application and organize only the desired information for customized display) instead of relying on other clinicians (e.g. radiologists) to provide the information needed and understand the priority and image and information display protocol the surgeon or clinician want to be displayed.

### SUMMARY OF THE INVENTION

Briefly, according to one aspect of the present invention a medical evaluation system for a procedural event comprises: determining key medical images and medical reports; determining a clinician's preferences for medical records obtained from a physician; determining the clinician's preferences for clinical information system records; determining the clinician's preferences for display of the medical images, medical reports, medical records, and clinical information system records; and displaying the medical images, medical reports, medical records, and clinical information system records.

In preparation for surgery, many surgeons and other clinicians are presented with a problem in the gathering and displaying of information without tedious, manual interventions. Either there is an overload of information, from many sources, or the information is difficult to find and often not used. This invention provides a methodology that allows for the customization of a computerized preparation and reporting system for surgeons and other clinicians in preparation for surgery or other events such as an examination requiring special preparation and attendance by a clinician. Examples are angiography, interventional radiology or others where the procedure can be invasive, minimally invasive or non-invasive. It includes information from other clinicians, medical records and preferences as to the means and method of display of this information in a simple and easy-to-understand program.

### BRIEF DESCRIPTION OF THE DRAWINGS

FIG. 1 is a general flow diagram of the present invention.

FIG. 2A is a detailed flow diagram of the present invention.

FIG. 2B is a detailed flow diagram of the present invention.

FIG. 3 shows a representation of image file for collaboration.

FIG. 4 shows a software embodiment screen shot of opening screen.

FIG. 5A shows a software embodiment of means to display patient relevant information.

FIG. 5B shows a software embodiment of means to display procedure specific information.

FIG. 6 shows a software embodiment of image display for multiple image procedures.

FIG. 7 shows a software embodiment of report display for multiple procedures.

FIG. 8 shows a software embodiment of remote database access.

FIG. 9 shows a software embodiment of display system for an operating room.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

In the present invention clinical information systems (CIS) is defined as any form of information provided from a clinical source. This includes hospital systems, regional health information organizations (RHIO), or from internal and remotely located clinicians (including specialists, nurses, therapists, other doctors or information from clinicians using the system). The data can be of digital or non-digital form in its original state, but input of non-digital data requires conversion to digital form for computer display. However, non-digital paper forms and reports, pictures or x-rays can be referred to in the system and noted to the clinician. The digital data used in the present invention can be clinical in nature, educational in nature (training, references, background info and the like), or include current or past (via video/audio files) collaborations with others.

The present invention includes methods for preparing the data for use in the system and allowing for multiple instantiations of the results depending on the intended use, such as one reporting system for in-office use and another for in-surgery use. In order to have a customizable system, two elements are added to the main reporting system seen and used by the clinician. The first is a set-up program and the other is a method to define and update preferences that the clinician may have.

The set-up program is used as a one-time means (modification is possible, of course) to configure the rudimentary features of the program. In software programs, this is akin to the page setup facility that sets defaults on layout, printer, and page size. In many cases this is done by the person preparing the system for use (support person, service provider or the clinician/staff). These include:
Text or image-centric interface
Storage and retrieval information for records
Features used in the system
Location where the reporting system will be used and the equipment at that location.
Collaboration choices and preparations (these include the vehicle for collaboration, communication means, availability, secondary choices for the collaborator being contacted, etc.)
Design templates for look and feel and placement of content
Other similar default settings

### Note, many different set-up files can be made and saved for later use.

The second is surgeon and clinician preferences that may need to be adjusted on a per case basis as the decisions here are pertinent to the specific case. For the most part, the clinician or a staff member, who is familiar with the surgery or clinical procedure workflow and the information used by that clinician in similar procedures, makes these decisions. In a preferred embodiment, this is a separate computer program used before the customized reporting system. Examples of surgeon or clinician preferences for the custom reporting system include (but are not limited to):
The particular radiographic and other medical images, reports and other content desired (teaching tools, past surgeries, illustrations, etc.)
Key images and preferred content from radiology information system/picture archiving and communication system (RIS/PACS) system
Hanging protocols (order in which the images appear, how many and where they are positioned on the display)
Hierarchy of the content (default to images, reports or other, most order options, etc.)
Medical records inclusion and where it is
Interaction preferences (who can interact and how, tele-illustration, device (mouse, voice, gaze, other), click or cursor enter options, etc.)
Default image for image-centric interface (i.e. 3D render, radiographic image, standard image(s))
Choice and content placement (what menu items used for background or region of interest (ROI)
How secondary data sources are accessed and the types of content to be requested, based on prior history for like procedures)
Which set-up program to use?
Collaboration preferences and set-up (to allow for electronic collaboration if desired as well as with whom and how the collaboration will be accomplished)
General look and feel (from templates or user defined, as well as the intended use)
The intended use for the custom report (for office work, patient explanation, pre-surgical planning or in-OR display)

The need for different views, based on the intended usage, allows for different user interfaces (hands free in the OR while a mouse may be preferred in the office or planning stages; the level of detail, number of views and resolution requires for images would be different in patient explanation versus planning; or any number of other differences as deemed appropriate by the clinician using the system). The concept of a multi-modal human/computer user interface is important to the usability of the custom reporting system. Not only for the hands-busy need for voice input in the operating room (OR), but for personal preference of the different pointing systems (mouse, joystick, wireless, touch, trackball, gesture, and others).

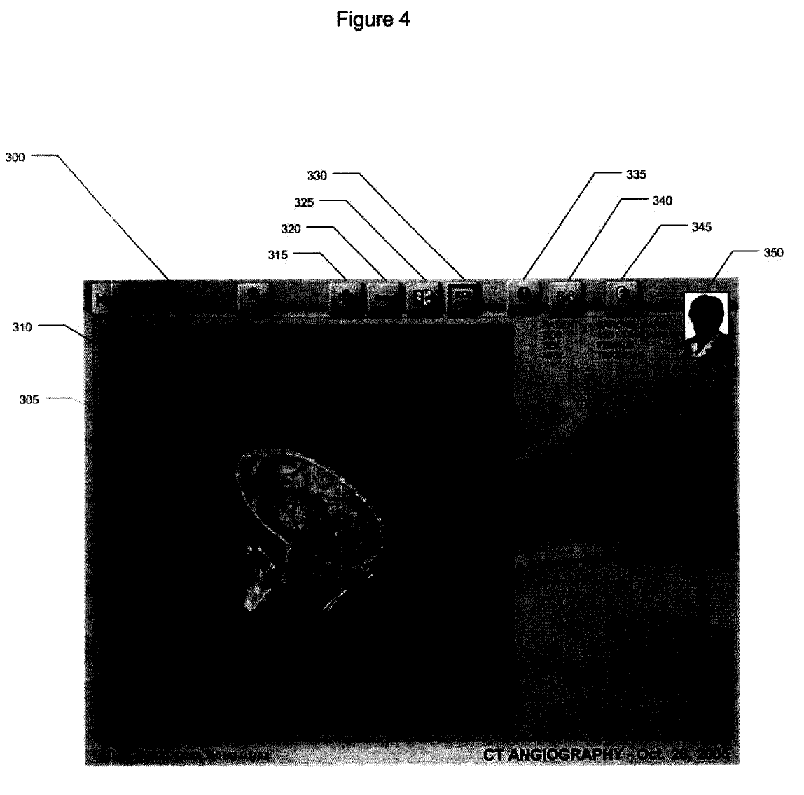

Many of these are shown in FIGS. 4-8. The graphical human/computer user interface for this program is standard choice selection and drag-and-drop for multiple choices. Other graphical user interface mechanisms may be used and are covered by the present invention.

In some cases the preferences are chosen at a different time and in a different program than the reporting system (although modification of these preferences is possible within the reporting system).

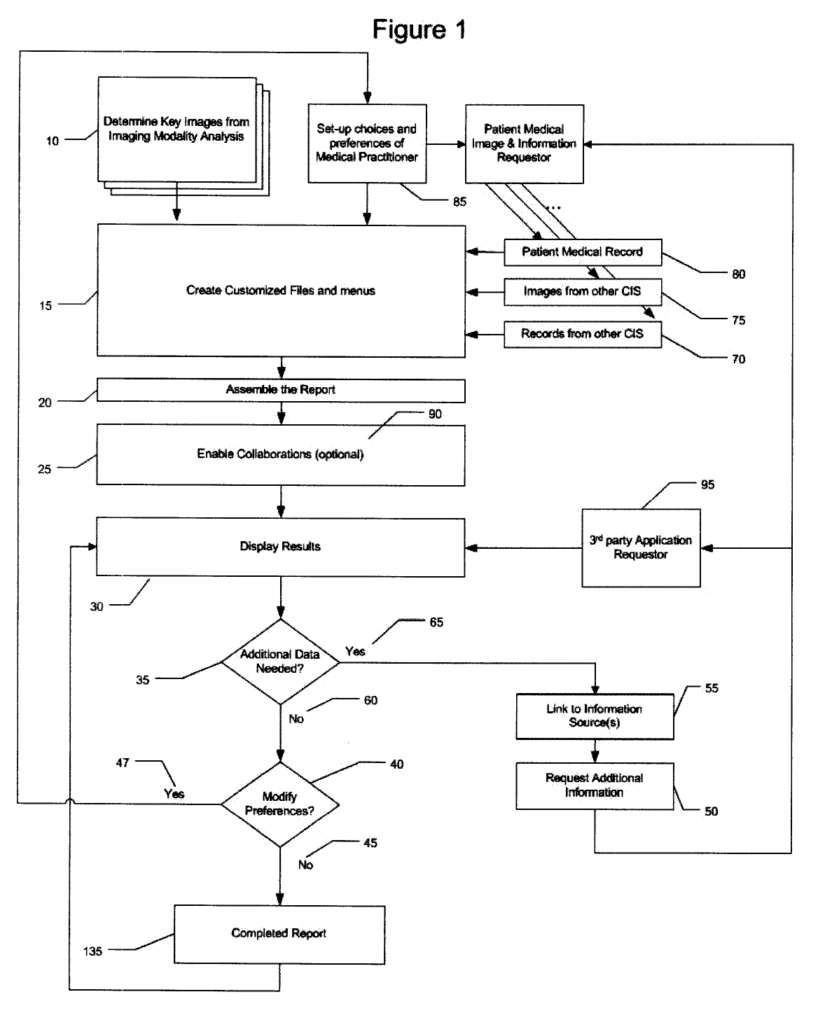

The customized reporting system is now ready to be implemented. FIG. 1 shows a flow diagram for the system. Only one of the input elements 10, 70, 75, 80 to the system is necessary as input to the system. Key images from the different modalities (as determined by the preference file) 10 and set up and preference information 85 are combined with the patient medical record 80, the images from other clinical information systems (CIS) 70 and data from other clinical information systems 75 and these files are compiled into the proper categories 15 as defined in the preference and set-up files 85. The customized report is assembled 20 using the hierarchy, hanging protocols and priorities as defined by the preference file 85. The system is then instructed to determine if collaboration has been requested as part of this request 25 and checks if the proper communications and networking connectivity is available. This is accomplished through standard communications and Internet protocols as found in any standard web browser or network-enabled desktop software application. The custom report is then displayed 30 and the surgeon, clinician or clerical worker under surgeon/clinician defined protocol(s) can decide if they wish to add additional data 35.

Additional information can be requested as a third party application 95 and added to the display results 30 in a separate window.

If there is a need for more data 65, the link to information source(s) 55 is used to identify potential sources of the additional data 65. The user can review available data and request additional information 50 using the patient medical image and information requestor 90. The patient medical image and information requester 90 uses the standard communications protocol to contact the appropriate data sources 70, 75, 80 and request the information. The information requested is then sent to the custom reporting system to create customized files and menus 15, assembled into a revised report 20 and displayed as revised report 30. This can be done at any time before or during the actual procedure.

If no additional data is needed 60, the system analyzes what has transpired to determine if a preference file modification should be made 40. For example, if a clinician accesses the same database for 20 out of 25 times for similar procedures, this would become a default information source instead of an optional one. If yes 47, the preference file 85 will be updated. If no 45, the completed report 135 made available for the system to display results 95 immediately and stored for subsequent display. This frequency of use analysis and preference file modification assessment 40 is optional.

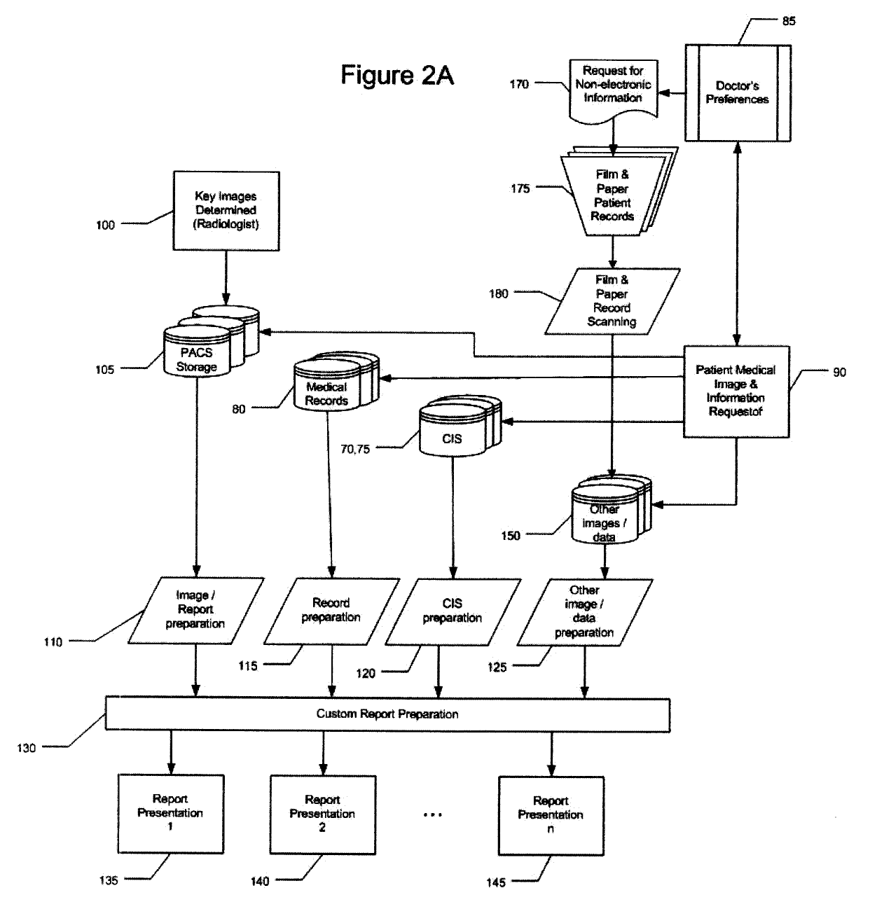

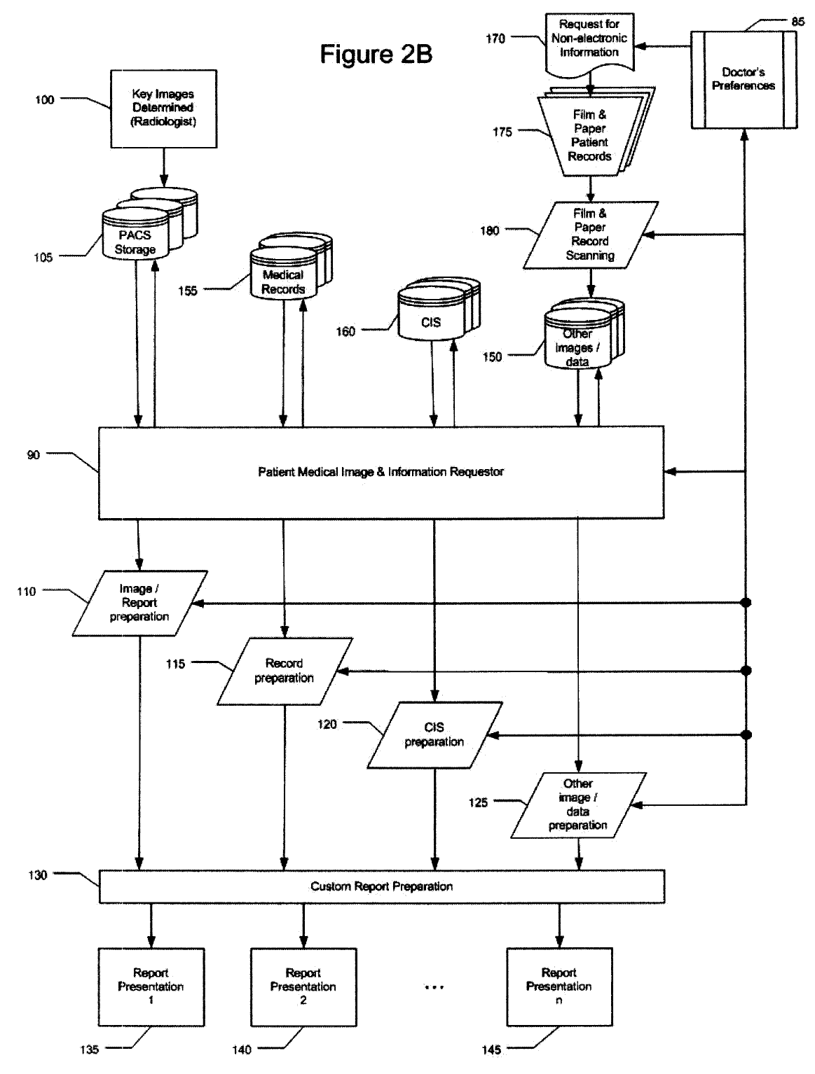

FIG. 2A is provided to show some additional detail as to how the preference file can affect different data sources. The doctor's choices and preferences 85 for the clinician are established and sent to the patient medical image and information requester 90 to identify the location of the requested information 105, 80, 70, 75, 150 and request the specific information be made available for use by preparation components 110, 115, 120, 125 of the present invention. Standard Internet protocols can be used to accomplish this. If the information needed to satisfy the doctor's preferences 85 can not be located by the patient medical image and information requestor 90 in electronic format in any of 105, 80, 70, 75, 150, a request for non-electronic information 170 is generated and sent to location(s) storing film and paper patient records 175. The request for non-electronic information 170 can take many forms such as fax, e-mail, postal letter, telephone call as is conventionally done to request patient images and records stored in paper or film format for traditional, non-digital usage in the OR.

Film and paper patient records are converted to digital format by the film and paper record scanning 180 operation using commercially available scanners such as the Kodak i40 and i100 series scanners and the Vidar X-Ray Film Scanner. The results of the film and paper record scanning 180 are stored in digital format in one of the other images/data 150 repositories. The scanning function may occur in several locations. One option is for the facility housing the paper and film patient records 175 to perform the scanning and transmit the resulting digital information to the other images/data 150 storage system using conventional digital media (e.g. CD or DVD) or Internet communications protocols. The digital information may be encrypted if required without materially affecting this invention. Alternatively, the facility may choose to send the original film and paper patient records 175 to the destination location using conventional means (e.g. postal service, courier service, hand carried by the patient) with the film and paper record scanning 180 function being performed at the destination location. A further variant would perform the film and paper record scanning 180 at an independent service provider location without affecting this invention. The other images/data 150 storage system is requested to send the information to the other image/data preparation station 125 that can convert the images and other data into a format usable by the current invention for custom report preparation 130. In many cases the information is already in a format that is usable and this step can be eliminated.

Radiology information is often kept in picture archive and communications system (PACS) storage 105. Preferences here may include, among other things: key images (as decided by the radiologist) 100, a video file of a scan, the radiologist's report, and a 3D rendering of the area of interest. The key images are often a standard output associated with a radiologist's report and it can be indicated via e-mail or note stored in the radiology system that the surgeon or clinician would like this information as a matter of routine for his patients. The PACS storage system 105 is requested to send the information to an image/report preparation station 110 that can convert the images and other data into a format usable by the current invention. In many cases the information is already in a format that is usable and this step can be eliminated. One example where the conversion may be needed is DICOM to JPEG image file conversion, or, due to privacy issues, the patient information is removed from the image/report and then sent to custom report preparation 130.

In custom report preparation 130, the information is combined with other sources of information, and other preferences (priority of this information, how displayed, etc.) to create the actual final report 135. Several other reports 140, 145 can be generated depending on specific preferences and the intended use of the report (pre-surgical planning, surgical reporting system in the OR, patient explanation or others). When requesting information 90 from a primary care physician (PCP), for example, regarding medical records 80, the surgeon or clinician of note may prefer 85 the entire record, specific issues (like allergies and alerts), procedure reports, or any number of others. This preferred information is brought into the present invention and records prepared 115 for integration with the other components 130 for a customized report 135, 140, 145.

Similarly, a clinical information system (CIS) 70, 75 may have pertinent information (such a pathology reports and images, urology reports, or any number of others). CIS preparation 120 is performed if needed to enable this information to be used for custom report preparation 130. Not only is the requested information itself a preference 85, but the hierarchy in which it is viewed in the custom report 135, 140, 145 is also preference as well.

Other sources of information not previously described can be found in one or more other image/data 150 storage locations, such as photographs in preparation for a cosmetic surgery, data from a regional health information organization (RHIO) and/or other physicians, can be handled and prepared 125 for use in custom report preparation 130 and reports generated 135, 140, 145.

Examples of preferences 85 here are: what pictures are to be included, what metadata is needed, who is the PCP, and others.

FIG. 2B describes a variation on the system described in FIG. 2A and is also covered under this invention disclosure. The component functions are as described in FIG. 2A unless otherwise described. One of the enhancements in the system shown in FIG. 2B is the expanded role of the patient medical image and information requestor 90. In addition to requesting the electronic records from 105, 80, 70, 75, 150, the patient medical image and information requestor 90 confirms receipt of the requested information and provides this status and the requested information to 110, 115, 120, 125 preparation components. This expanded confirmation role enables the patient medical image and information requestor 90 to provide a status of outstanding and fulfilled requests to the system, enabling it and the user to take additional actions to obtain tardy information.

In addition, the image/report preparation 110, record preparation 115, CIS preparation 120 and other image/data preparation 125 receive information about the doctor's preferences 85 that enable these functions to adapt the preparation based on direct knowledge of the doctor's preferences 85 information as well as the information actually received. Similar variations of this invention are possible but not exhaustively described as they will be obviously apparent to those skilled in the art.

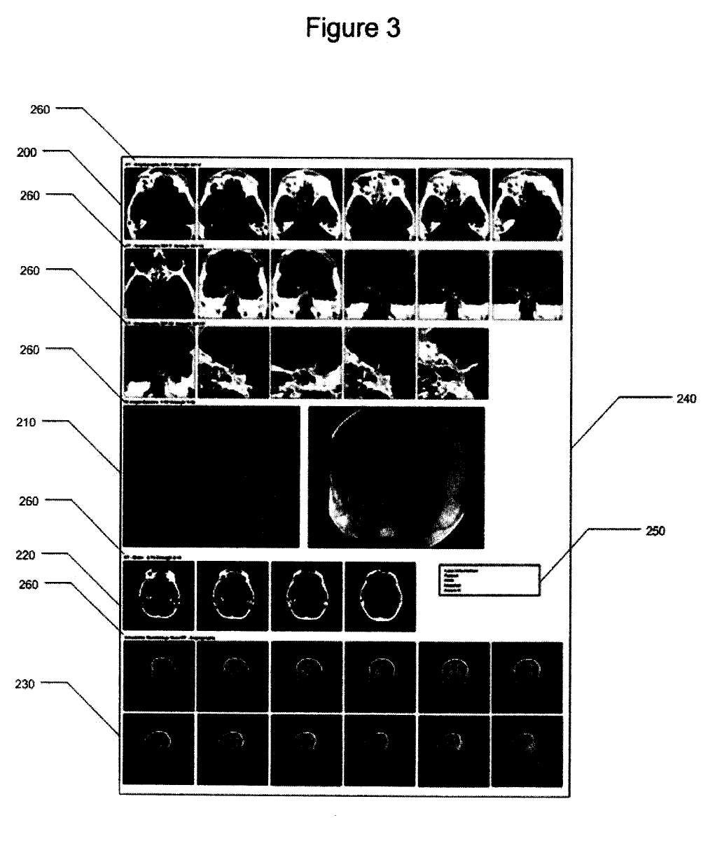

FIG. 3 is a representation of a combination of images that can be used for collaboration. All the images (and other data, if desired) in the custom report are combined into a single file 240. In this case, it is an image file that contains information from three separate procedures as well as 3D renderings. Images from Procedure A 200, Procedure B 210 and Procedure C 220 are shown as well as 3D renderings of Procedure B 230. Each set of images is labeled 260 and an area for identification of the patient and the current procedure 250 is also provided. This potentially very large image is then converted to a format conducive to collaboration (such as JPEG 2000) and stored on a server. This allows for the image to be shared very quickly over the Internet with multiple people and also allows for interactivity (zoom, pan, etc.) as well as annotations from the multiple collaborators. The present invention takes the images from the custom report, builds the file, adds the annotations, performs the file conversion, and stores the image on a predetermined server.

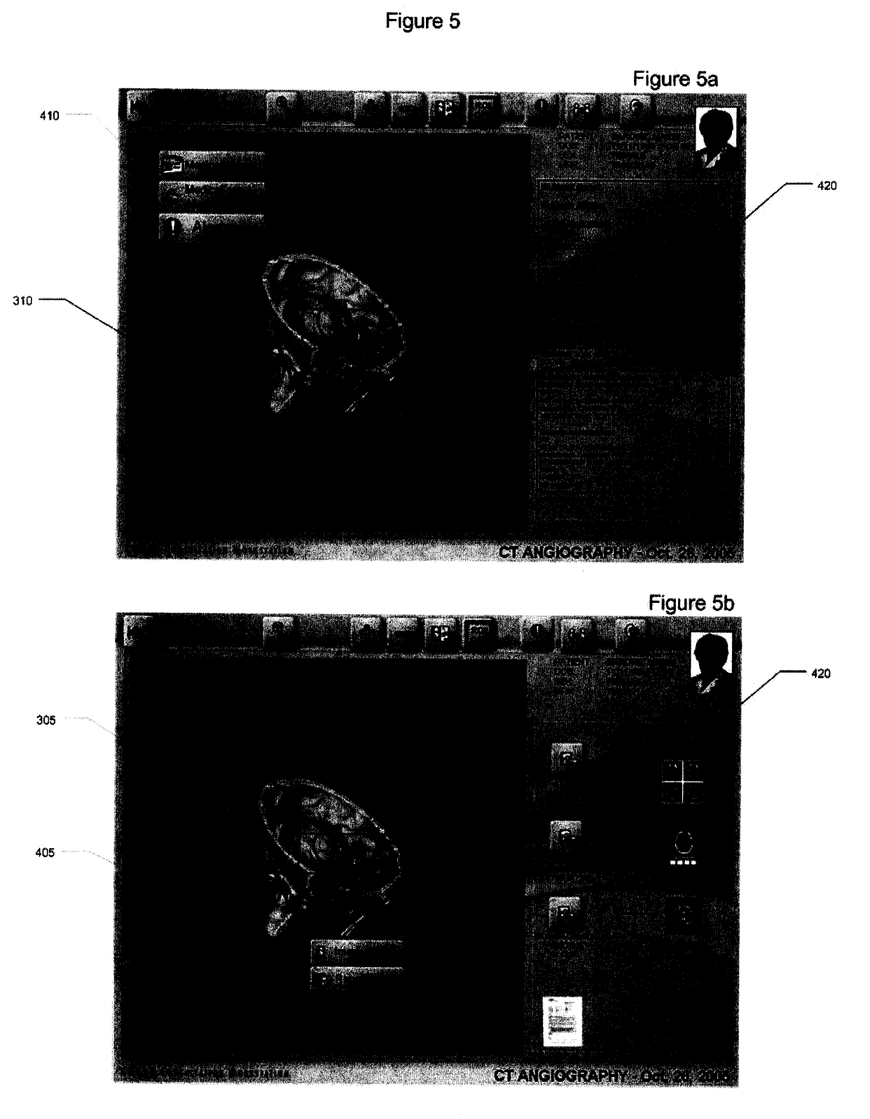

FIGS. 4-8 show an example instantiation of the present invention from the perspective of the surgeon or clinician performing the procedure. FIG. 4 is an example of an initial screen to a custom reporting system. This example is for a surgeon who is about to perform brain surgery for an aneurism in the area known as the “Circle of Willis.” The screen 300 shows an image-centric menu system that was chosen from the preferences (a traditional text-based menu system is also available via the preferences). There are two regions of interest displayed within the image, the entire image 310 and the Circle of Willis area of the brain 305. These areas allow different menus to appear (these menus are shown in FIG. 5). This screen displays some of the options available to the user. There is the ability to customize the menu choices by adding 315 or subtracting 320 items from the menus, accessing a remote database 325 (a location where additional information that can be added for the add feature 315), and to turn off the frames surrounding the regions of interest (ROI) 330. Several of the standard image features are also available (zoom, pan, etc.). These standard image features are also available on all subsequent images presented in the system. There is also the ability to show alerts 335 such as current medications and allergies, the ability to collaborate in real-time with other physicians 340 or others who may have input or interest, such as a medical educational institution, and a standard help feature 345. Identification of the patient 350 is always shown.

FIGS. 5A and 5B show the essence of how the graphics interface works. In FIG. 5A, when the background ROI 310 is selected (e.g. a mouse click), a menu 410 appears giving the user access to general medical information about the patient such as the medical record, medications and allergies, or special alerts. When a specific menu item is selected, the information appears in a window on the display 420 next to the background ROI 310. The information available for selection from menu 410, and the location and format of the information area 420 on the display are default settings that can be customized in the doctor's preferences 85.

Similarly in FIG. 5B, when the Circle of Willis ROI 305 is selected, a menu 405 appears showing the options for the images or reports that are of interest for this particular surgery or procedure. It is the menu from ROI 405 and menu from background 410 that are some of the items to which content can be modified by the user as shown in FIG. 4 the icon for adding menu information content 315 and icon for removing menu information content 320. Other items that can modify content are described in subsequent figures.

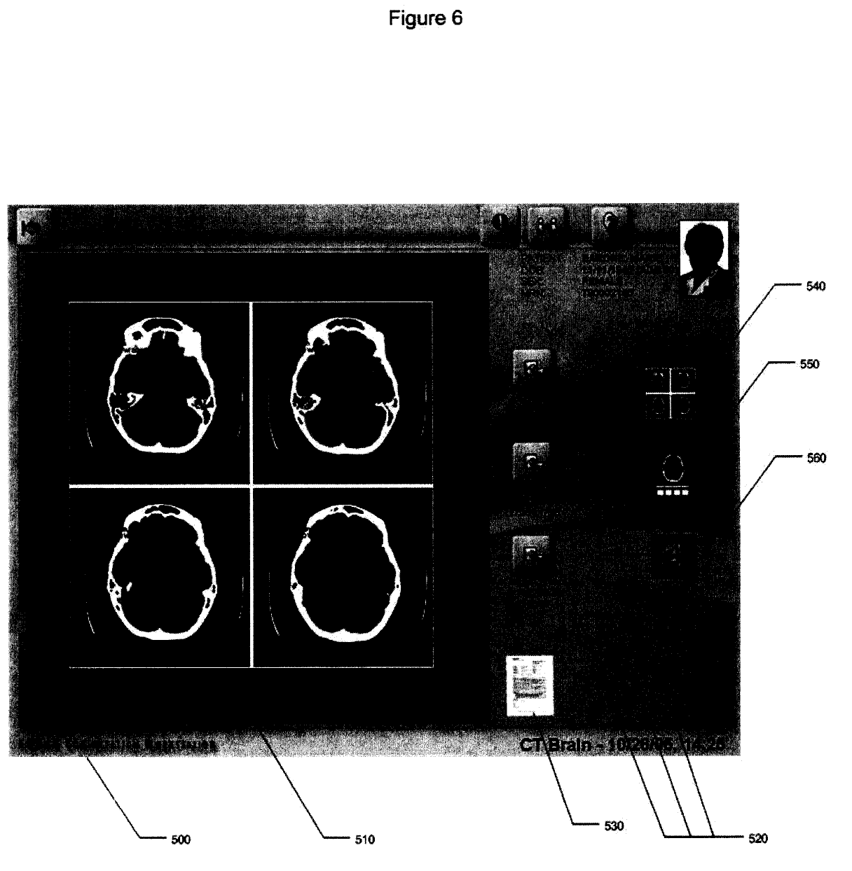

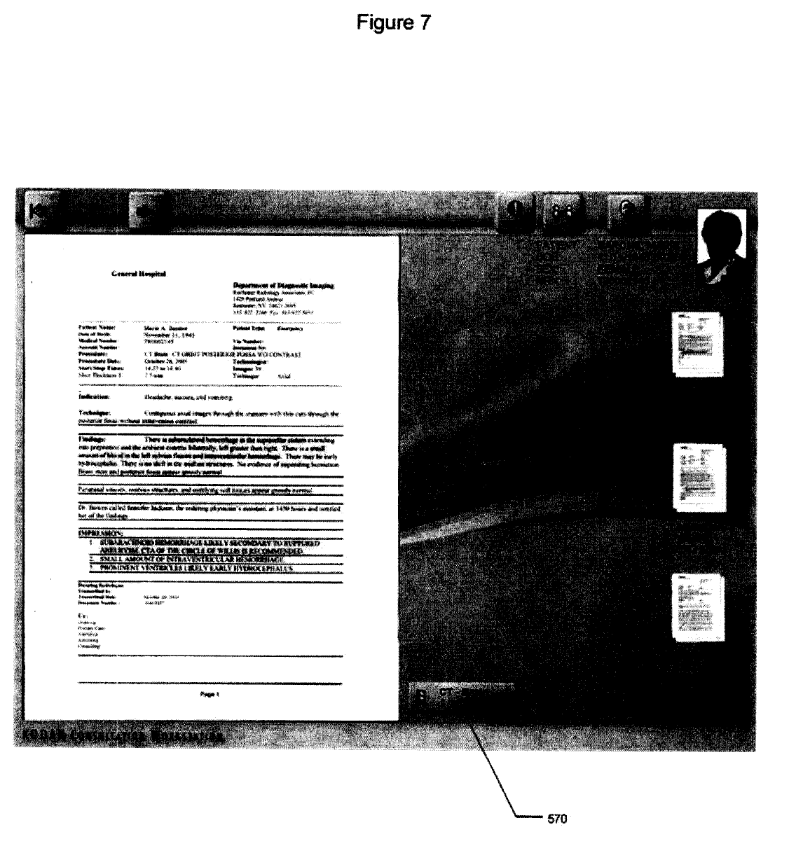

FIG. 6 shows an embodiment of the resultant screen 500 produced by the action of choosing the images option in the menu 405 in FIG. 5. The hierarchy of display for this report is provided in the preferences file 85 described earlier as is the hanging protocols (the way in which the content is displayed). All of the relevant imaging procedures are represented 520 as well as the subset of information available from these imaging procedures 540, 550, 560. This subset of information has been chosen by a combination of key information as decided by the clinician responsible for the procedure (such as a radiologist) and the preferences the surgeon or clinician has described as components of the procedure he finds particularly useful. In this example, the radiologist has determined the key images for the procedure 540 and the surgeon has also requested (via the preferences) a video 550 and 3D rendering 560. By using the hierarchy in the preferences, the key images 540 are displayed 510 by default. Access to the corresponding report(s) for the imaging procedure displayed is available using an icon 530 on the image screen. Conversely, an image icon 570 on FIG. 7 is also shown on the reports screen that links to the corresponding images used to generate that report. The content displayed in this area of the reporting system on both FIGS. 6 and 7 can be customized (i.e. content can be added 315 or removed 320 in FIG. 4). All of the content on these display screens are sharable and can be used for collaboration with any number of other surgeons and other clinicians or consultants. JPEG 2000 technology, streaming technology over the Internet, or Video conferencing technologies are used for this (all well known in the art).

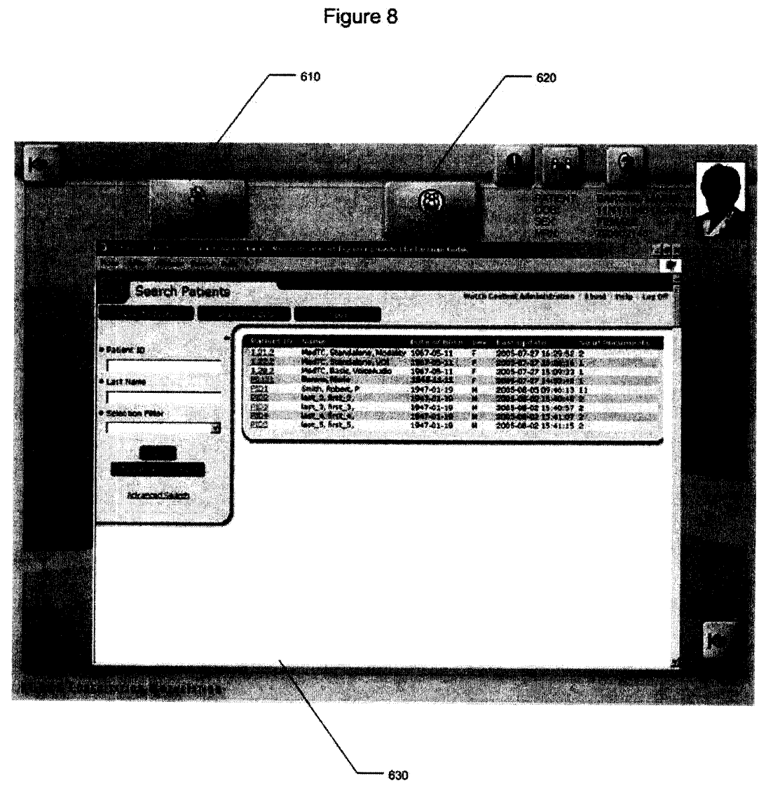

FIG. 8 is an example of how an archive of content 630 can be displayed and content found. Similar search capability is standard in all database applications. In addition, the custom reporting system of the present invention allows for network or Internet access 610 to outside sources of information and allows for a directory 620 of surgeons and other clinicians and consultants to be made available.

Key to this concept is how it differs from a simple link to a RIS/PACS system in the OR. The present invention is meant to be easy-to-use, automated and customizable. None of these are apparent in a simple link to a RIS/PACS system as it requires significant training to become proficient is using RIS/PACS functionality originally designed to meet the needs of diagnostic radiologists and there is little customization provided. It is the easy access to the potentially vast patient medical record data, the extraction of the most relevant information for the surgical or clinical procedure and the display protocol specified in the doctor's preferences 85 that is most important for the surgical or clinical procedure that makes this especially valuable. Another difference here is the all inclusive, integrated solution (retrieval, storage, collaboration, and assessment).

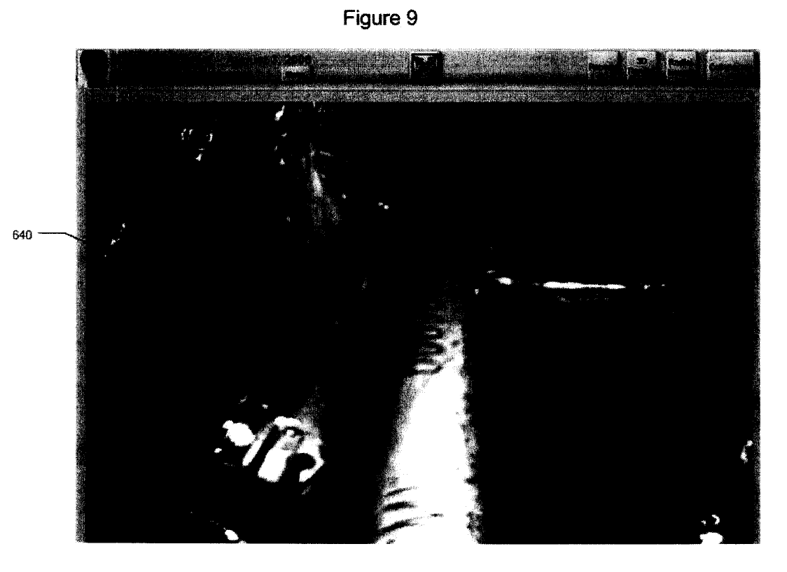

FIG. 9 shows another embodiment of a custom reporting system with an emphasis on the inclusion of live imagery from a laparoscopic system 640 that would also be allowed as a component of this integrated, customizable surgical/clinical imaging and information system, as opposed to being separate system. In laparoscopic surgery and endoscopic procedure cases, it would be appropriate for the default view to be the live video from laparoscope/endoscope 640 and have this on screen (perhaps as a window) when other data is presented.

Image recognition methods (like those used to associate objects in consumer photography or find objects in images in security applications) can be used to further the ease of use and utility of this reporting system. Finding these objects in the medical images can make determining the ROIs much easier. In addition, knowledge of the patient orientation can allow all the relevant imagery be aligned accordingly. This could potentially improve the workflow and reduce errors. This could be easily accomplished by having an orientation icon added to the screen, which allows the clinician or assistant, at the time of the procedure, to determine how the patient is oriented and the images would change their orientation to match that of the patient.

The use of tele-illustration (like that seen on sports broadcasts like Monday Night Football) can be used with this system to aid in collaborative efforts. Unlike the sports broadcasts, however, this functionality could be used by any of those collaborating on the procedure, regardless of their location. This is shown in web-based demonstrations exampled by annotations using the Zoomify™ toolkit (www.zoomify.com).

It is intended that the present invention be usable in several forms depending on the network architecture and computing resources deployed at each site (e.g. as a stand-alone application, accessible via a local area network or over the Internet). While certain features would not be available in the stand-alone version (such as remote collaboration), the utility of the system would remain.

The invention has been described in detail with particular reference to certain preferred embodiments thereof, but it will be understood that variations and modifications can be effected within the scope of the invention.

### PARTS LIST

10 determine key images
15 create files and menus
20 assemble report
25 collaborations
30 display results
35 more data needed
40 modify preferences
45 no preferences modified
47 preferences modified
50 request additional data
55 link to data source
60 no additional data needed
65 additional data needed
70 records from another CIS
75 images from another CIS
80 medical record of patient
85 doctor's choices and preferences
90 patient medical image and information requester
95 third party application request
100 key images determined
105 PACS storage (radiological information)
110 image and/or report preparation from PACS
115 record preparation from medical records source
120 preparation of CIS records
125 preparation of other images or data
130 preparation of custom report
135 different report presentations
140 different report presentations
145 different report presentations
150 other image and data source
170 requests for non-electronic information
175 film and paper patient records
180 film and paper record scanning
200 images from Procedure A
210 images from Procedure B
220 images from Procedure C
230 rendered images from 3D view
240 representation of total image file
250 identifier of image file
260 labels of different procedures and imagery
300 initial screen shot
305 ROI area of image used for graphical user interface
310 background area of image used for graphical user interface
315 icon for adding menu information content
320 icon for removing menu information content
325 icon for activating remote archives
330 icon for removing boxes showing ROI
335 icon for alerts
340 icon for collaboration
345 icon for help
350 patient identification information
405 menu from ROI
410 menu from background
420 information area
500 screen from “images” option
510 key images representation
520 icons representing procedures of interest
530 icon of means to switch to report view of current procedure
540 different content from the chosen procedure
550 different content from the chosen procedure
560 different content from the chosen procedure
570 icon of means to switch to images view of current procedure
610 icon for locating network resources
620 icon for locating surgeons and other clinicians
630 representation of database being accessed
640 video from laparoscope/endoscope

1. A medical evaluation system for a procedural event comprising:
determining key medical images and medical reports;
determining a clinician's preferences for medical records obtained from a physician;
determining the clinician's preferences for clinical information system records;
determining the clinician's preferences for display of the medical images, medical reports, medical records, and clinical information system records; and
displaying the medical images, medical reports, medical records, and clinical information system records.

2. The medical evaluation system of claim 1 wherein the medical images are radiological images.

3. The medical evaluation system of claim 1 comprising the additional step of:
dynamically adding or subtracting additional information.

4. The medical of evaluation system of claim 1 comprising the additional step of:
interactively collaborating with other medical personnel.

5. The medical of evaluation system of claim 1 wherein: the medical reports comprise audio annotations, video representations, and three-dimensional renderings.

6. The medical evaluation system of claim 1 comprising the additional step of:
interacting with additional medical databases.

7. The medical evaluation system of claim 1 comprising:
a setup system to allow default choices to be made.

8. The medical evaluation system of claim 1 comprising the additional step of:
providing a means to determine preferences for said medical evaluation system.

9. The medical evaluation system of claim 1 comprising the additional step of:
providing a graphical user interface that allows for quick recognition of different patients and cases.

10. The medical evaluation system of claim 1 comprising the additional step of:
providing a means for a digital assistant for pre-surgical planning.

11. The medical evaluation system of claim 1 comprising the additional step of:
providing a means for a digital assistant for procedural event information display and navigation.

12. The medical evaluation system of claim 1 comprising:
generating multiple reports for patient consultation, procedural event planning, procedural event display, and post procedural event consultations.

13. A method of generating a custom image file of preferred full resolution images for a patient procedural event.

14. A method as in claim 13 wherein the custom image file is adaptable to addition of new data as specified by a clinician.

15. A method as in claim 13 wherein the custom image file includes patient identification labels and image procedure identification labels.

16. A method as in claim 13 comprising:
converting and storing preferred full resolution images in a predetermined file server.
